(19) United States
(12) Patent Application Publication
(10) Pub. No.: US 2014/0209449 A1
(43) Pub. Date: Jul. 31, 2014

(54) METHOD FOR REPROCESSING WASTE WATER AND WATER REPROCESSING DEVICE

(71) Applicants: Andreas Büttner, Stolzenberger Hof (DE); Thomas Hammer, Hemhofen (DE); Martin Tackenberg, Forchheim (DE); Gernut Van Laak, Nürnberg (DE)

(72) Inventors: Andreas Büttner, Stolzenberger Hof (DE); Thomas Hammer, Hemhofen (DE); Martin Tackenberg, Forchheim (DE); Gernut Van Laak, Nürnberg (DE)

(73) Assignee: SIEMENS AKTIENGESELLSCHAFT, Munich (DE)

(21) Appl. No.: 14/239,394

(22) PCT Filed: Aug. 1, 2012
(86) PCT No.: PCT/EP2012/064999

§ 371 Date: Feb. 18, 2014

(30) Foreign Application Priority Data
Aug. 16, 2011 (DE) 10 2011 081 015.3

(51) Int. Cl. C02F 1/04; C02F 1/66

(52) U.S. Cl. CPC C02F 1/048; C02F 1/66
USPC 203/10

(57) ABSTRACT

A method reprocesses waste water containing an organic acid from an industrial process. A base is added to the acid-containing waste water. A salt dissolving in the waste water is produced due to a neutralization reaction. The waste water is subsequently guided in a heat exchanger process, a heat exchange medium being used such that the waste water which is to be treated is partially evaporated and is condensed into purified water on a condensation device. A concentrate enriched with the salt forms a residue and the purified water is guided back into the industrial process.

### CROSS REFERENCE TO RELATED APPLICATIONS

This application is based on and hereby claims priority to International Application No. PCT/EP2012/064999 filed on Aug. 1, 2012 and German Application No. 10 2011 081 015.3 filed on Aug. 16, 2011, the contents of which are hereby incorporated by reference.

### BACKGROUND

The invention relates to a method for reprocessing wastewater, and also to a water treatment machine.

Aseptic packages are a basic requirement, in particular in food technology, in order to ensure the shelflife of perishable foods even without cooling. Wet disinfection of plastic packages, such as, for example, PET bottles, with dilute peracetic acid has developed to be one of the standard processes used therefor in the food industry and particularly in the drinks industry. The disinfection is carried out in this case using aqueous peracetic acid solution which contains a mixture of typically 2000 mg per liter of peracetic acid and hydrogen peroxide in water. In order to remove the residues of the disinfectant before the foods are charged, washing with high purity sterilized water is performed. The resultant wastewater always still contains considerable amounts of the disinfectant, that is to say the peracetic acid, and therefore cannot be fed without pretreatment to a biological effluent treatment plant.

A separation of water and acid by distillation, owing to the closely adjacent boiling points of the substances participating, is not possible technically. Therefore, even a partial recovery of the rinse water is not currently possible.

For disposal, therefore, lye is added in a controlled manner, which lye neutralizes the aqueous solution of peracetic acid and acetic acid. The neutralized lye is then fed to the standard wastewater. Although this procedure solves the disposal problem, it does not contribute to lowering water and energy consumption in wet disinfection, e.g. in the food industry.

In a commercially conventional plant for wet disinfection, per rinsing line, several thousand liters of rinse water per hour are produced. In addition, there is also the energy consumption for producing the sterile water.

In the patent document U.S. Pat. No. 7,163,631, it is proposed to pass peracetic acid-containing wastewaters through a tank in which they are intensively contacted with air before further treatment is performed, e.g. by contacting with anaerobic biologically active sludges. The data reported there on residence times and aeration rates in the aeration tank allow it to be concluded that the aeration tank requires a capacity which corresponds to the rinse water consumed in 2.5 hours and that, per m³ of rinse water, around 15 m³ must be bubbled through the aeration tank in order to make subsequent chemical reduction of the peracetic acid superfluous. This may reduce the costs of the chemical treatment of the wastewater, but recovery of rinse water is not achieved thereby.

### SUMMARY

One possible object is to decrease the water consumption in industrial purification processes, in particular in wet disinfection of food packages, wherein the potential for saving energy is to be provided.

The inventors propose a method for reprocessing an industrial process wastewater that comprises an acid. This method involves:

Firstly, to the wastewater which originates, for example, from a rinse process in the production of packaging, is fed a base (lye) by which at least part of the acid (usually peracetic acid and/or acetic acid) contained in the wastewater is neutralized. The neutralized wastewater is then introduced into a heat-exchange process. In this case, a heat-exchange medium is used, which is formed in such a manner that the wastewater that is to be treated is heated to a vaporization temperature which is between 60° C. and the boiling point of the wastewater. The heat-exchange medium can be either a liquid or a gaseous medium. The temperature of the heat-exchange medium can be in the range in which the wastewater is to be heated, but it can also have a markedly higher temperature, in particular in the case of gaseous media. The amount of heat which is transferred in the heat-exchange process from the heat-exchange medium to the wastewater depends very greatly on the mass flow rates and also on the state of matter of the heat-exchange medium.

Second, the wastewater, which has the abovedescribed temperature between 60° C. and the boiling point of the wastewater, is vaporized and then recondensed. It may be pointed out that, according to the proposal, this concerns a vaporization process below the boiling point of the wastewater. The neutralized wastewater that is purified in the vaporization and condensation process is then returned to the industrial process. However, it can, in principle, be fed to the general water supply since it is effectively microbe-free.

The proposed method has various advantages. The first advantage is that, using the proposed method, up to 80% of the process water used, that is to say the rinse water from the packages, which occurs as wastewater, can be recovered and returned to the process. In this case the process of the method is markedly less energy consuming than the expenditure of fresh water for process water.

The method described is beneficial energetically, especially, when the heat-exchange medium is in a thermal circuit with the waste heat of a second thermal process. In particular, since the evaporation of the wastewater is a vaporization process which takes place at relatively low temperatures, it is also possible to use waste heat from industrial processes which are below 100° C. Generally, processes having waste heat in this temperature range, from 60° C. to 100° C., cannot be recovered, but are discharged to the environment. This is therefore an energetically expedient and ecological method.

In a further advantageous embodiment, fresh water for an industrial process is treated, wherein the fresh water is subjected to a high-temperature treatment of above 100° C., in particular above 140° C. As a result of such a high-temperature disinfection, all microbes still possibly present in the fresh water are definitively eliminated. For energetically expedient configuration of this per se energy-intense high-temperature disinfection, it is expedient to preheat the fresh water by waste heat. In this case, for example, the fresh water can be passed in advance through a condenser of the condensation device, wherein the heat of condensation is transmitted at the condenser to the fresh water. After the high-temperature disinfection, a further heat exchanger can be provided which removes the heat again from the heated fresh water. This heat which is taken off from the fresh water can in turn profitably be employed for heating up the wastewater to a vaporization temperature or approximate vaporization temperature (The term vaporization temperature is understood to mean a temperature of between 60° C. and the boiling point, which promotes the vaporization). Afterwards, it can be expedient to use the heat energy taken off from the heated fresh water again for heating up new fresh water for the high-temperature disinfection.

The inventors further propose a water treatment machine for reprocessing a wastewater that contains an acid. This machine comprises a neutralization device for neutralizing the wastewater by a base, and also a wastewater collecting device, and is distinguished in that a heat exchanger is provided for heating up the wastewater to a vaporization temperature which is between 60° C. and the boiling point of the wastewater. The boiling point of the wastewater, depending on pressure conditions and the substances dissolved in the wastewater (after the neutralization, in particular salts), is generally between 95 and 110° C. In addition, the machine comprises an evaporation device, wherein the evaporation device serves for partial vaporization of the heated wastewater. After the vaporization, the vaporized wastewater is condensed in a condenser.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic process depiction for the water flow of rinse water for rinsing packages in the food industry as per the related art,

FIG. 2 shows a rinse water recovery system having an evaporator and condenser and UV radiation in schematic form,

FIG. 3 shows a more detailed depiction of the rinse water recovery system as per FIG. 2.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

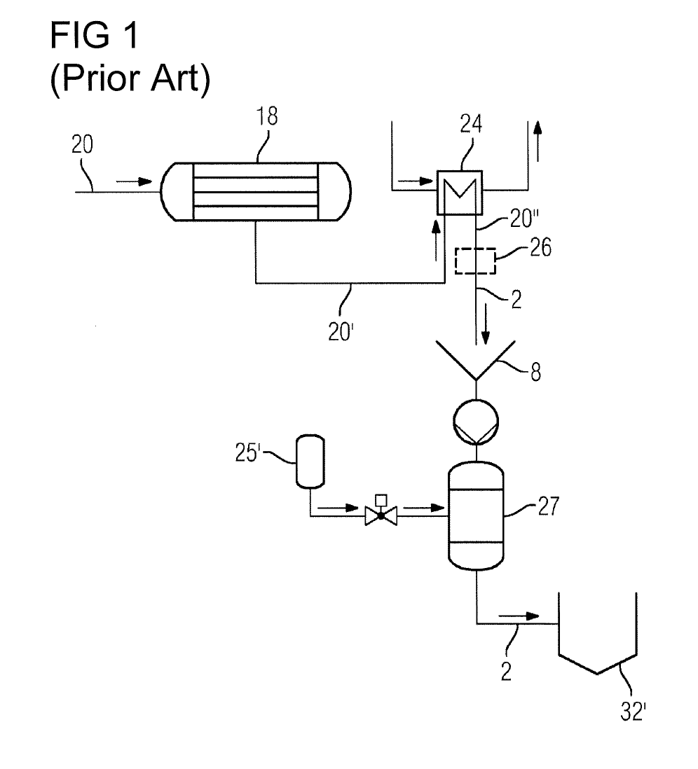

The current related art for treatment and disposal of rinse water, as is employed, for example in the food industry, is explained on the basis of FIG. 1. Firstly, fresh water 20 is added to a reverse osmosis system 18, wherein the fresh water thus treated 20′, for achieving an absolute freedom from microbes, is subjected to a further thermal high-temperature treatment, this proceeds in a high-temperature disinfection system 24. The fresh water 20″ which is made microbe-free by these processes, is then added to an industrial process. For example, PET bottles, for example for the drinks industry, can be rinsed by this process. This process, which can have as many embodiments as desired, is designated in FIG. 1 and in the following figures schematically as water utilization device 26. If one remains with the example that PET bottles must be rinsed for the drinks industry, a wastewater 2 which arises after the rinse operation, is contaminated with peracetic acid or with acetic acid and H₂O₂. This originates from the fact that the peracetic acid is used quite generally for disinfection of PET bottles in the drinks industry and in the food industry.

The wastewater 2 which then contains the organic acid peracetic acid, or else acetic acid, is collected in a wastewater collecting device, wherein this wastewater collecting device is shown here schematically by a funnel. Alternatively in this case, this can be only a conduit tube, a corresponding collecting tank need not necessarily be present. According to the related art, the wastewater 2 thus contaminated with an organic acid is pumped into a neutralization device 27, wherein, from a base container, a base or a lye is added to the neutralization device 27 in such a manner that the wastewater 2 therein possesses a pH as neutral as possible. The acetic acid or peracetic acid present therein is therefore neutralized with a suitable lye or base. The wastewater 2 thus neutralized is passed as residual water 32 into the sewage system.

The residual water 32′ is not reused in the related art.

Although the described method of the related art leads to no contaminated water being delivered into the surroundings, a very large amount of fresh water which likewise must be treated in an energetically expensive manner is required.

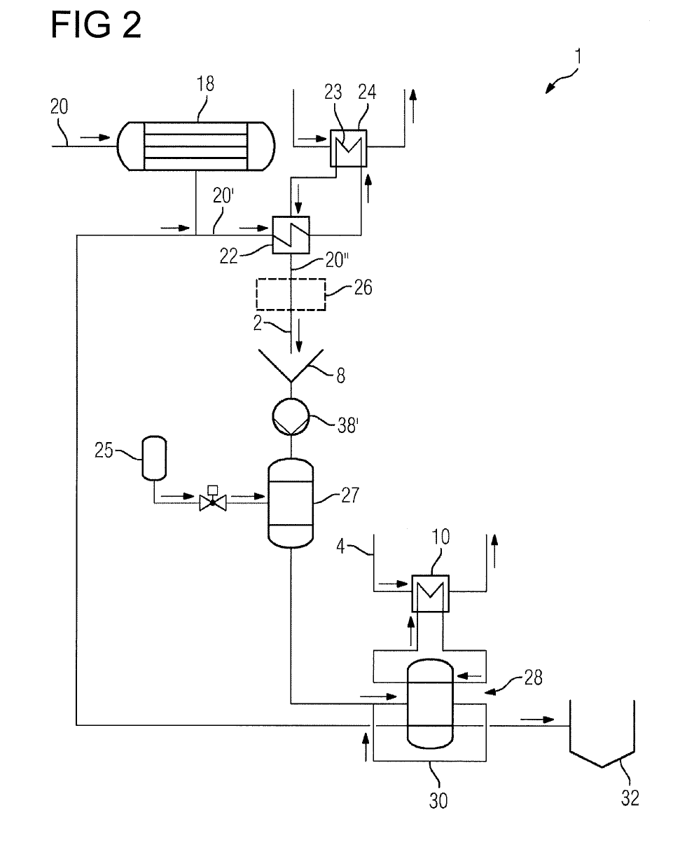

In FIG. 2, a water treatment device 1 is shown in a simplified manner schematically starting from FIG. 1, which water treatment device 1 in this example is likewise based on the system according to FIG. 1 and it should likewise be assumed by way of example thereof that at this point PET bottles are disinfected with peracetic acid and are rinsed with the fresh water 20. This likewise proceeds in a water utilization device 26, wherein wastewater 2 arises. This wastewater 2 is conveyed into a neutralization device 27, with base being fed in from a base container to neutralize the peracetic acid. The aim here is for addition of base matched stoichiometrically to the acid content of the wastewater. The neutralization, though, must proceed only to an extent such that the pH of a residual water is environmentally compatible—this pH may also be slightly basic.

In contrast to the related art as per FIG. 1, in FIG. 2, the wastewater 2 is collected in the wastewater collecting device 8 and added to a wastewater treatment device 28. The wastewater treatment device 28 is shown in very simplified form in FIG. 2, it comprises, inter alia, a vaporization device 12 and a condenser device 14.

In this case, the wastewater 2 is preheated by a heat exchanger 10 to a vaporization temperature which causes a vaporization of the wastewater 2. Vaporization in this case is taken to mean water passing from the liquid phase to the gas phase, wherein the temperature is below the boiling point.

This has the advantage that, for the heat-exchange process for heating up the wastewater 2, waste heat from a further industrial process 46 can be utilized which otherwise would be released unrestrictedly to the surroundings on account of the relatively low temperature thereof. This concerns, in particular, waste heat which is typically associated with temperatures between 60° C. and 100° C.

In processes 46 having gaseous waste heat, the temperature can also typically be 400° C. (waste heat from a gas turbine). Here, it is possible that the gaseous waste-heat medium is fed directly as heat-exchange medium 4 to the heat exchanger 10 or whether a further heat-exchange process which is not shown is connected intermediately. Gaseous heat-exchange media have a lower heat-transfer coefficient than liquid heat-exchange media. To achieve the desired vaporization temperatures of the wastewater 2, accordingly, the heat-transfer coefficients must be taken into account and the required mass flow rates must be calculated from the waste heat of the process 46 according to the available temperature.

These relatively low temperatures from the waste heat of the process 46 can be utilized a further time in an energetically rational manner using the wastewater treatment device 28 described, which in this embodiment, is advantageous for the entire energy balance of the water treatment device 1.

Around the wastewater treatment device 28, a conduit 30 is drawn in schematically, which is intended to illustrate the fact that the vaporization and condensation process of the wastewater 2 can possibly proceed many times repetitively.

The purified water 44 can, as is shown by the arrow, having the number 44 in FIG. 2, be added back to the rinse process, represented by water utilization device 26. The water 44 purified by the described water treatment device 28 is in itself aseptic and also preferably has no residues of acids, but for use in the food industry an additional high-temperature disinfection 24 can be required, for which reason the purified water 44 is added a further time to such a disinfection device 24, before it is again available for the rinse process.

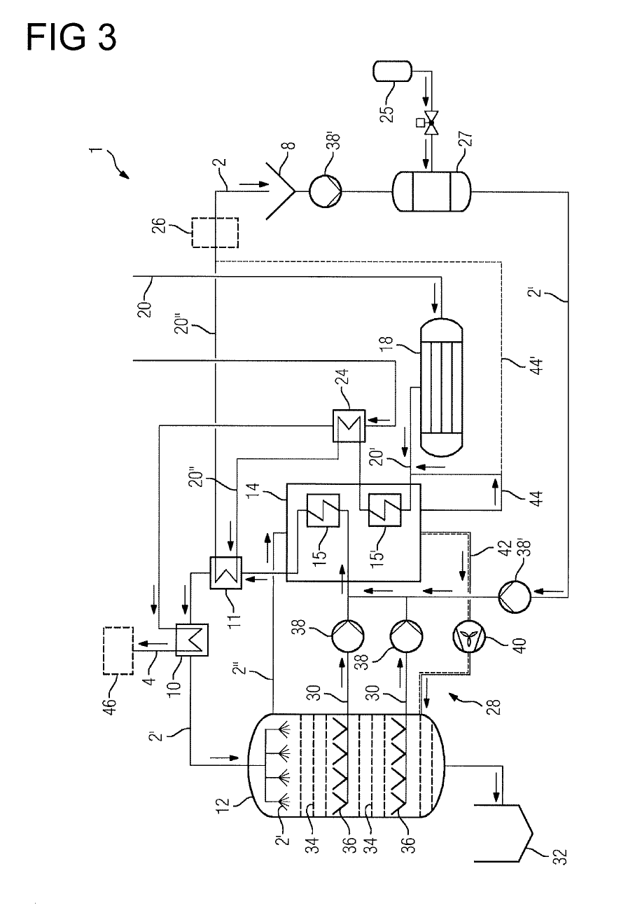

In FIG. 3, the water treatment device 1 described schematically in FIG. 2 is shown in more detail. In particular, in FIG. 3, the wastewater treatment device 28 with the evaporation device 12 and the condenser device 14, and the interaction of individual heat exchangers 10, 11, which contribute to minimizing the energy requirement, are described.

As already discussed with reference to FIG. 2, a fresh water 20 is added to a reverse osmosis system 18, the thus pretreated fresh water 20′ is heated to about 140° to 150° C. in a high-temperature disinfection device 24 in order to ensure the absolute freedom from microbes of the thus treated fresh water 20″, which is used as rinse water in a water utilization device 26.

If the arrow labeled with the reference sign 20′ and which exits from the reverse osmosis system 18 is followed, the fresh water 20′, before it is passed into the high-temperature disinfection device 24, is first passed into a condenser 15′, which is part of the wastewater treatment device 28. In the condenser 15′, the fresh water 20′ is preheated, since in the condensation process, which will be considered further hereinafter, heat of condensation is liberated by the condensation, wherein the condenser 15′ acts as heat exchanger and the fresh water 20′ is preheated using the heat of condensation. The energy requirement which is needed in the high-temperature disinfection device 24 and which is added, in particular, in steam form, for example via a steam generator, is already decreased in this case, since the waste heat from the condensation process can be profitably used for the high-temperature disinfection 24. The high-temperature disinfection 24 also takes place only for a very short time which is sufficient to kill off all microbes from the fresh water 20′. The fresh water 20″ treated in this manner, which in turn has a relatively high temperature, is then sent via a further heat exchanger 11 in which it is again cooled to a temperature which is usable for the rinse operation. The heat exchanger 11 and the heat exchanger 23 in the high-temperature disinfection system 24 are thus in constant interchange, and so in this process, only very little heat energy is lost. The heat taken off from the fresh water 20″ in the heat exchanger 11 is used further at another point of the process, which will be considered further.

In principle, it can also be expedient to utilize the heat taken off from the fresh water 20″ after the high-temperature disinfection for preheating the fresh water 20′ for the high-temperature disinfection process. This is not shown in this form in FIG. 3, but is outlined in FIG. 2 by a preheating device 22. A heat exchanger 23 of the high-temperature disinfection device 24 is therefore in constant thermal exchange with a heat exchanger of the preheating device 23. In the case of good thermal insulation, the heat energy which is required for the high-temperature disinfection and needs to be constantly supplied to the system is very low.

To return to FIG. 3: the fresh water 20″ is then added to the water utilization device 26, that is to say, as already repeatedly described by way of example, PET bottles are rinsed. After the rinse operation, the former fresh water 20″ is a wastewater 2 contaminated with organic acid. This wastewater 2 is collected in the wastewater collecting device 8 and pumped by a pump 38′ into the neutralization device 27. There, the neutralization takes place as described in FIG. 2.

The neutralized wastewater 2′ is subsequently passed into the wastewater treatment device 28, as is indicated by the pump 38′. Hereinafter, the mode of action of the wastewater treatment device 28 will be considered in more detail. The relatively cold wastewater 2′, in an advantageous embodiment, is firstly passed through a condenser 15, the mode of action of which will be considered hereinafter. As already mentioned, this condenser 15 gives off heat of condensation, which is utilized for heating up the wastewater 2′. Subsequently, the wastewater 2′ is sent through the abovementioned heat exchanger 11, as a result of which it is further heated. Finally, the wastewater 2′ is further heated up in the heat exchanger 10, wherein a heat medium 4 can be in thermal contact with the waste heat of a further industrial process 46. The wastewater 2 is heated by the heat exchangers 11 and 10 to a temperature which is between 60° C. and the boiling point of the wastewater 2′. The boiling point of the wastewater 2′ can fluctuate around the boiling temperature of the pure water, depending on the dissolved substances (acetic acid, peracetic acid, surfactants or salts). Boiling temperatures between 95° C. and 110° C. can usually occur.

The wastewater 2′ that is preheated to this vaporization temperature is then introduced into the evaporation device 12 and atomized there. The wastewater 2′ lands on vaporizer surfaces 34, which can be fabricated from differing materials, for example from cellulose materials. The vaporizer surfaces 34 are distinguished, in particular, in that they have a very high surface area in relation to their base area. The wastewater 2′ is converted on the vaporizer surfaces 34 into the gas phase by vaporization, wherein the wastewater 2″ then present in gaseous form is introduced via the conduit marked 2″ into the condenser device 14. In the condenser device 14, condensers 15 and 15′ are arranged, the mode of action of which has already been described. On the condensers 15 and 15′, the wastewater 2″ condenses to re-form water which is in itself then microbe-free and purified. It is removed from the condenser device 14 as purified water 44.

Since, depending on the embodiment of the wastewater treatment device 28 and depending on the configuration of the vaporizer surfaces 34, and also depending on the amount of the wastewater 2′ introduced into an evaporation and condensation cycle, not all of the wastewater 2′ can be evaporated, in the evaporation device 12 collection funnels 26 are provided in which the non-evaporated wastewater 2 is collected, and is pumped off from the evaporation device 12 by a pump 38. The wastewater 2′ that is thus collected again is likewise passed through the condenser 15, it is heated again in this process by the heat of condensation and in a further cycle is passed through the heat exchangers 11 and 10 back into the evaporation device 12. This corresponds to the arrow 30 indicated in FIG. 2 that leads back a return line of the wastewater 2 for further repetitive vaporization and condensation. In addition, there is a further conduit between the condensation device 14 and the evaporation device 12, wherein, via a fan 40, air is exchanged via an air equalization device 42 between these two devices 12 and 14.

A small part of the wastewater 2 which is concentrated with salts and surfactants which cannot be treated by the device described is fed as residual water 32 to the sewage system.

The purified water 44 can then again be fed to the rinse process or the water utilization device 26. There are two alternatives therefor. For extremely high demands which are of relevance to freedom from microbes, the purified water 44 can be subjected a further time to the high-temperature disinfection 24 and passed via the bypass as fresh water 20″ through the heat exchanger 11 to the water utilization device 26. Since the purified water is in itself already virtually microbe-free, it can be expedient in various applications to conduct a direct conduit, which is shown with dashed lines in FIG. 3 with 44′, to the water utilization device 26 and to feed in there directly this purified water 44 again. In this case, an energetically more complex high-temperature disinfection could be dispensed with.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-6. (canceled)

7. A method for reprocessing an acid-containing wastewater, comprising:
adding a base to the acid-containing wastewater;
neutralizing the acid-containing wastewater to produce a salt which is in solution in wastewater;
introducing the wastewater into a heat-exchange process;
heating the wastewater that is to be treated with a heat-exchange medium to a vaporization temperature which is between 60° C. and a boiling point of the wastewater;
partially vaporizing the wastewater and condensing the wastewater on a condensation device as purified water, with a concentrate remaining that is enriched with the salt;
supplying the purified water to an industrial process;
treating fresh water for the industrial process by subjecting the fresh water to a temperature treatment of above 100° C.; and
preheating the fresh water in thermal equilibrium with the condensation device.

8. The method as claimed in claim 7, wherein the heat-exchange medium is in a circuit with waste heat from a second thermal process.

9. The method as claimed in claim 7, further comprising taking heat off from the temperature-treated fresh water by a heat exchanger and adding the heat to the wastewater to heat the wastewater to the vaporization temperature.

10. The method as claimed in claim 7, further comprising heating up the fresh water before the temperature treatment by taking heat off from the temperature-treated fresh water by a heat exchanger.

11. The method as claimed in claim 8, further comprising taking heat off from the temperature-treated fresh water by a heat exchanger and adding the heat to the wastewater to heat the wastewater to the vaporization temperature.

12. The method as claimed in claim 11, further comprising heating up the fresh water before the temperature treatment by taking heat off from the temperature-treated fresh water by a heat exchanger.

13. The method as claimed in claim 7, wherein the base is lye.

14. The method as claimed in claim 7, wherein the acid is peracetic acid or acetic acid.

15. The method as claimed in claim 7, wherein the heat exchange medium is a gaseous medium or a liquid medium.
